(19) United States
(12) Patent Application Publication
(10) Pub. No.: US 2026/0133687 A1
(43) Pub. Date: May 14, 2026

(54) METHOD, APPARATUS, DEVICE AND PRODUCT FOR GENERATING INTERACTIVE VIEW

(71) Applicant: Beijing Zitiao Network Technology Co., Ltd., Beijing (CN)

(72) Inventor: Honghao ZENG, Beijing (CN)

(21) Appl. No.: 19/388,937

(22) Filed: Nov. 13, 2025

(30) Foreign Application Priority Data
Nov. 14, 2024 (CN) 202411630463.6

(51) Int. Cl. G06F 3/0488; G11B 27/031

(52) U.S. Cl. CPC G06F 3/0488; G11B 27/031

(57) ABSTRACT

The present disclosure relates to a method, an apparatus, a device and a product for generating an interactive view. The method comprises acquiring information of a visual element in an audio or video. The method further comprises displaying the visual element during playback of the audio or video based on the information of the visual element. In addition, the method further comprises generating an interactive view corresponding to the visual element in response to a user’s touch operation on the displayed visual element.

### CROSS-REFERENCE TO RELATED APPLICATIONS

This application claims priority to Chinese Application No. 202411630463.6, filed on November 14, 2024, the disclosure of which is incorporated herein by reference in its entirety.

### FIELD

The present disclosure relates to the field of computers, and more specifically to a method, an apparatus, a device and a product for generating an interactive view.

### BACKGROUND

During playback of an audio or video, a user often needs to interact with visual elements therein. These visual elements, including stickers, texts and other forms of graphic elements, are all designed to be presented at a specific time or in a specific scene in the video. As the user’s demands for personalized content increases, audio and video processing technologies are undergoing changes and developments, and devoted to enhance users’ experience and achieve more precise and richer interaction with visual elements.

In order to meet the users’ demands for interaction with visual elements, interactive views are widely used in the relevant art. The interactive views are usually in the form of selection boxes, operation menus, etc. and can respond to the users’ operations such as clicking, dragging and dropping, etc. Through these operations, the user may further edit or control visual elements in the video, for example, adjust their positions, sizes, styles, etc., thereby enhancing the personalization and interactivity of the video. The application of this technology not only improves the users’ participation and experience, but also provides more possibilities for the creation and editing of audio/video content.

### SUMMARY

In a first aspect of embodiments of the present disclosure, there is provided a method for generating an interactive view. The method comprises acquiring information of a visual element in an audio or video. The method further comprises displaying the visual element during playback of the audio or video based on the information of the visual element. In addition, the method further comprises generating an interactive view corresponding to the visual element in response to a user’s touch operation on the displayed visual element.

In a second aspect of embodiments of the present disclosure, there is provided an apparatus for generating an interactive view. The apparatus comprises an information acquisition module configured to acquire information of a visual element in an audio or video. The apparatus comprises a visual element display module configured to display the visual element during playback of the audio or video based on the information of the visual element. In addition, the apparatus further comprises an interactive view generation module configured to generate an interactive view corresponding to the visual element in response to a user’s touch operation on the displayed visual element.

In a third aspect of embodiments of the present disclosure, there is provided an electronic device. The electronic device comprises one or more processors; and a storage device for storing one or more programs which, when executed by the one or more processors, cause the one or more processors to implement a method for generating an interactive view. The method comprises acquiring information of a visual element in an audio or video. The method further comprises displaying the visual element during playback of the audio or video based on the information of the visual element. In addition, the method further comprises generating an interactive view corresponding to the visual element in response to a user’s touch operation on the displayed visual element.

In a fourth aspect of embodiments of the present disclosure, there is provided a computer program product. The computer program product is tangibly stored on a non-transitory computer-readable medium and comprising computer-executable instructions that, when executed, cause a machine to implement a method for generating an interactive view. The method comprises acquiring information of a visual element in an audio or video. The method further comprises displaying the visual element during playback of the audio or video based on the information of the visual element. In addition, the method further comprises generating an interactive view corresponding to the visual element in response to a user’s touch operation on the displayed visual element.

The Summary is provided to introduce a selection of concepts in a simplified form that are further described below in the Detailed Description. This Summary is not intended to identify key features or essential features of the disclosure, nor is it intended to limit the scope of the disclosure.

### BRIEF DESCRIPTION OF THE DRAWINGS

The above and other features, advantages and aspects of embodiments of the present disclosure will become more apparent with reference to the following detailed description when taken in conjunction with the figures. In the figures, the same or like reference numerals denote the same or like elements, wherein:

FIG. 1 illustrates a schematic diagram of an example environment in which embodiments of the present disclosure may be implemented;

FIG. 2 illustrates a flow chart of a method for generating an interactive view according to some embodiments of the present disclosure;

FIG. 3 illustrates a flow chart of a method of creating a dictionary and generating an interactive view based on the dictionary according to some embodiments of the present disclosure;

FIG. 4 illustrates a schematic diagram of an example of a module that generates and displays an interactive view according to some embodiments of the present disclosure;

FIG. 5A illustrates a schematic diagram of an example of creating a dictionary according to some embodiments of the present disclosure;

FIG. 5B illustrates a schematic diagram of an example of generating an interactive view based on hierarchy information according to some embodiments of the present disclosure;

FIG. 6 illustrates a block diagram of an apparatus for generating an interactive view according to some embodiments of the present disclosure; and

FIG. 7 illustrates a block diagram of a device capable of implementing embodiments of the present disclosure.

### DETAILED DESCRIPTION OF EMBODIMENTS

It may be appreciated that all user-related data involved in this solution should be obtained and used after authorization by the user. This means that, in the present technical solution, if the user’s personal information needs to be used, before these data is obtained, the user’s explicit consent and authorization are required, otherwise relevant data collection and use will not be performed. It should also be understood that in the implementation of the present technical solution, relevant laws and regulations should be strictly observed during the collection, use and storage of data, and necessary techniques and measures should be taken to ensure the safety of the user’s data and the safe use of the data.

It may be appreciated that prior to using the technical solutions disclosed in the embodiments of the present disclosure, the user should be notified of the type, scope of use, use scenario, etc. of personal information involved in the present disclosure and authorization be obtained from the user in an appropriate manner according to relevant laws and regulations.

For example, in response to reception of the user’s active request, prompt information is sent to the user to explicitly prompt the user that an operation he requests to perform needs to obtain and use his personal information. Accordingly, the user may autonomously select, according to the prompt information, whether to provide the personal information to software or hardware such as an electronic device, an application, a server or a storage medium, which executes the operations of the technical solution of the present disclosure.

As an optional but non-limiting implementation, in response to reception of the user’s active request, the prompt message may be sent to the user, for example, in the form of a pop-up in which the prompt message may be presented in a text. In addition, the pop-up may further carry a selection control for the user to select “agree” or “disagree” to provide the personal information to the electronic device.

It is to be understood that the above-described processes of notifying and obtaining the user’s authorization are merely illustrative and not be construed as limiting the implementations of the present disclosure, and that other ways compliant with relevant laws and regulations may also be applied to the implementations of the present disclosure.

Hereinafter, embodiments of the present disclosure will be described in more detail with reference to the accompanying drawings. Although certain embodiments of the present disclosure have been illustrated in the accompanying drawings, it is to be understood that the present disclosure may be embodied in various forms and should not be construed as being limited to the embodiments set forth herein; rather, these embodiments are provided to enable the present disclosure to be understood more thoroughly and completely. It should be understood that the drawings and embodiments of the present disclosure are for illustrative purposes only and are not intended to limit the scope of the present disclosure.

In the depictions of the embodiments of the present disclosure, the term “include” and like words should be understood as being open-ended terms, i.e., mean “include, but not limited to”. The term “based on” should be understood as “based, at least in part, on”. The term “one embodiment” or “the embodiment” should be understood as “at least one embodiment”. The terms “first”, “second” and the like may refer to different or identical objects unless expressly stated otherwise. Other explicit and implicit definitions may also be included below.

In the related art, before playing the audio or video, a system pre-computes and generates all possible interactive views, and then stores the interactive views in an invisible manner. When the video is played to a preset time, corresponding visual elements are displayed, and the system will display the previously-generated interactive views according to a pre-set rule or logic for the user to click or perform other forms of operations. However, even if these interactive views are in a hidden state, they need to consume a lot of resources for rendering and computation. When a high-resolution video and a video containing a large number of visual elements are processed, such performance overhead is particularly large, which might lead to device performance degradation and affect the fluency and stability of video playback.

In addition, even if some interactive views are not actually used by the user, the system allocates resources and storage space for them, which causes unnecessary waste. Such waste of resources is particularly evident in scenarios where there is little or no user interaction. Meanwhile, since the system needs to maintain and manage a large number of interactive views, the user may encounter a response delay after clicking on the screen. In complex interaction scenarios, such a delay might be further exacerbated, thereby affecting the continuity and satisfaction of the user’s experience.

To this end, the present disclosure provides a method for generating an interactive view. Firstly, information of a visual element in an audio or video is acquired, then the visual element is played in a playback process of the audio or video according to the acquired information, and finally an interactive view corresponding to the visual element is generated after the user’s touch operation on the displayed visual element is detected. In this way, only after the user performs a touch operation on a displayed visual element is generated an interactive view corresponding to the visual element, which avoids unnecessary memory occupation, thus reducing the overall resource consumption of the system, improving the response speed and system performance, and bringing about a smoother and more satisfactory interactive experience to the user.

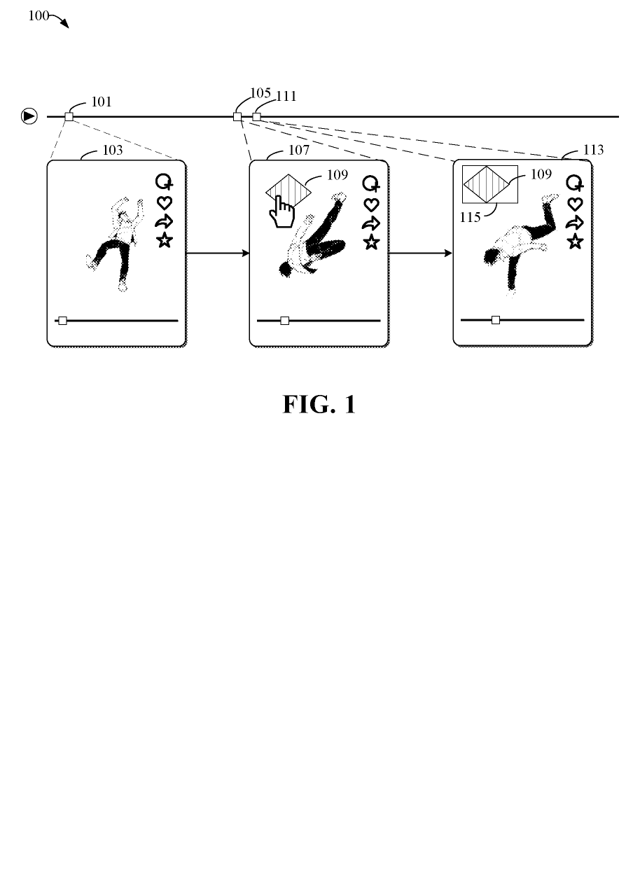

FIG. 1 illustrates a schematic diagram of an example environment 100 in which embodiments of the present disclosure may be implemented. It should be appreciated that the playback of a video or audio is typically performed at a client. The client can play the content through various devices such as a smart phone, a tablet computer or a television TV, and perform processing such as decoding and rendering for the audio or video data received from the audio or video engine, thereby playing the audio or video. These audio or video data may be transmitted to the client in various forms, for example, may be transmitted to the client by means of an audio or video draft as a carrier, may be played in real time in a stream transmission manner, and may also be downloaded locally and then played. A specific transmission manner may be selected as actually needed.

As described above, at a specific time of video or audio playback, the client may render stickers, text or other forms of visual elements, and provide the user with a way of interacting with the audio or video engine. In embodiments of the present disclosure, the client may acquire information of the visual element via a video draft received from the video engine. The information may comprise a type, a style, an animation effect, transparency, a trigger condition, a display time range, position information, etc. of the visual element, and the client may determine a rendering effect, a rendering timing and a rendering position of the visual element according to relevant information. Then, the visual element is rendered onto a video page for presentation to the user during the playback of the video. For example, as shown in FIG. 1, at different time points during video playback, the client will present corresponding video frames according to the current playback progress. At time 101, the client displays a video page 103; at time 105, as the playback progress advances, the client displays a video page 107 that comprises a visual element 109.

In some embodiments, the trigger condition of the visual element may be set as the user’s touch operation on the visual element; when the user’s touch operation on the visual element is detected, the client may acquire interactive view information corresponding to the visual element touched by the user through a video draft received from the video engine; certainly, the client may also acquire information of the interactive view upon acquiring the information of the visual element, and the acquisition timing may be specifically selected as actually needed, to achieve the purpose of rendering the interactive view. After obtaining the information of the interactive view, the client may determine information of the interactive view such as the style, the position, the display time range, etc., and then generate the interactive view and render the interactive view to a position corresponding to the visual element. For example, as shown in FIG. 1, at time 105, the user performs a touch operation on the visual element 109, and at time 111, the client renders a video page 113 that comprises an interactive view 115. Thus, the user may achieve interaction with the audio or video engine through the touch operation on the interactive view. As shown in FIG. 1, the interactive view 115 is a rectangular box; upon specific implementation, the interactive view may also be any other figure or in any other style, and the specific presentation form of the interactive view in the present disclosure is not limited.

In this way, when the user does not perform the touch operation on the displayed visual element, the client will not generate the interactive view in advance; only after the user performs the touch operation on the displayed visual element is generated the interactive view corresponding to the visual element, thereby avoiding unnecessary memory occupation, reducing the overall resource consumption of the system, improving the response speed and system performance, and bringing about a smoother and more satisfactory interactive experience to the user.

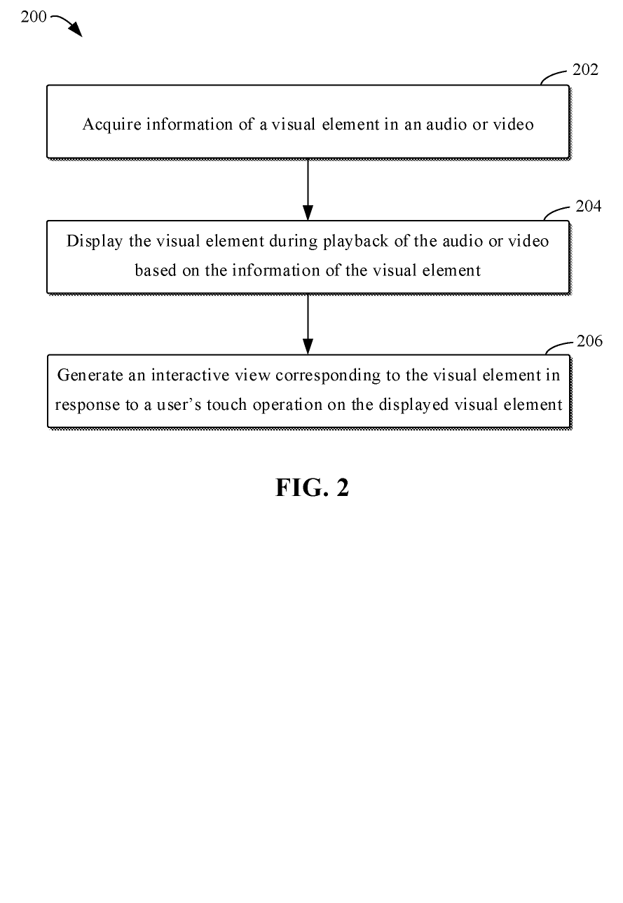

FIG. 2 illustrates a flow chart of a method 200 for generating an interactive view according to some embodiments of the present disclosure. The method 200 may be performed by a client. The method 200 comprises block 202, block 204, and block 206.

As shown in FIG. 2, at block 202, information of a visual element is acquired from an audio or video. Referring to FIG. 1, a client may obtain information of the visual element from data transmitted by an audio or video engine, and the data may be transmitted in the form of an audio or video draft as a carrier. When the audio is played, the visual element may be lyrics scrolling, an album cover, a playback progress bar, a control button, etc. When the video is played, the visual element may be a label, a sticker, a bullet comment, a character, etc. The interactive visual element in the audio or video may be set in advance. This is not limited in the present disclosure. The information of the visual element may comprise a type, a style, an animation effect, transparency, a trigger condition, a display time range, position information, etc. of the visual element, and the client can determine a rendering effect, a rendering timing and a rendering position of the visual element according to the relevant information.

At block 204, the visual element is displayed during playback of the audio or video based on the information of the visual element. Referring to FIG. 1, the client may decode data sent by the audio or video engine to determine the rendering effect, the rendering timing, and the rendering position of the desired visual element, and render the visual element onto a page for presentation to the user during audio or video playback. For example, at time 101, the client displays a video page 103; at time 105, as the play progress advances, the client displays a video page 107 that comprises the visual element 109.

At block 206, an interactive view corresponding to the visual element is generated in response to the user’s touch operation on the displayed visual element. Referring to FIG. 1, upon detecting the user’s touch operation on the visual element, the client may acquire the interactive view information corresponding to the visual element touched by the user through a video draft received from the video engine; after acquiring the information of the interactive view, the client may determine information of the interactive view such as the style, the position, the display time range, etc.; then, the client generates the interactive view and renders the interactive view to a position corresponding to the visual element. For example, as shown in FIG. 1, at time 105, the user performs the touch operation on the visual element 109; at time 111, the client renders the video page 113 that comprises the interactive view 115. As such, the user may achieve interaction with the audio or video engine through the touch operation on the interactive view.

In this way, when the user does not perform the touch operation on the displayed visual element, the client will not generate the interactive view in advance; only after the user performs the touch operation on the displayed visual element is generated the interactive view corresponding to the visual element, thereby avoiding unnecessary memory occupation, reducing the overall resource consumption of the system, improving the response speed and system performance, and bringing about a smoother and more satisfactory interactive experience to the user.

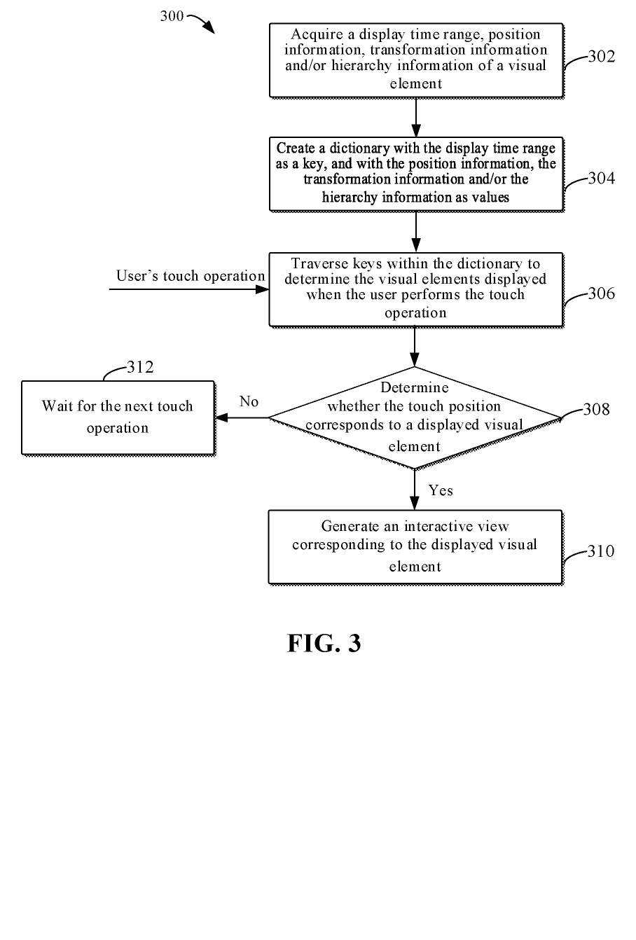

FIG. 3 illustrates a flow chart of a method 300 for creating a dictionary and generating an interactive view based on the dictionary according to some embodiments of the present disclosure. The method 300 may be performed by a client. At block 302, a display time range, position information, transformation information and/or hierarchy information of a visual element is acquired. In some embodiments, the client may decode data received from a video engine to acquire the display time range, the position information, the transformation information, and/or the hierarchy information. The display time range represents a specific time period in which the visual element appears in the audio or video, for example, a sticker is displayed starting from the 5^{th} second of the video until the end of the 10^{th} second. The position information represents an exact position and a size of the visual element on the screen. In some embodiments, a rectangular area may be used for description. The rectangular area may comprise four parameters, i.e., x, y, width, and height, wherein x represents a horizontal position of an upper left corner of the element, y represents a vertical position of the upper left corner of the element, the width represents a width of the visual element, and the height represents a height of the visual element. In some embodiments, if the element undergoes a transformation operation such as rotation, scaling, or translation in the video, the client will also capture the transformation information. Finally, the hierarchy information represents a position of the visual element in a stacking order, and the hierarchy information determines which visual element should be located at the topmost layer and be preferentially seen or responded to when a plurality of visual elements overlap.

At block 304, a dictionary is created with the display time range as a key, and with the position information, the transformation information and/or the hierarchy information as values. When a piece of audio or video comprises a plurality of visual elements, the client may, after acquiring information about the plurality of visual elements, perform structural processing on the acquired information. Upon specific implementation, information of the visual elements displayed successively may be correspondingly arranged in a dictionary in order of the display time range. For example, if visual element A is displayed in a range from the 5^{th} second to the 8^{th} second, and visual element B is displayed in a range from the 8^{th} second to the 11^{th} second, information of visual element A is directed as a value under a key of [5, 8] seconds, and information of visual element B is directed as a value under a key of [8, 11] seconds. The key may be understood as an index, and relevant information under the index may be efficiently and conveniently queried according to the index.

At block 306, keys within the dictionary are traversed to determine the visual elements displayed when the user performs the touch operation. When the client detects the user’s touch operation, a touch time and a touch position may be determined first, and then the keys in the dictionary are traversed to find a display time range corresponding to the touch time, i.e., find a display time range comprising a touch time point. In this way, the client may determine which visual elements are displayed on the screen when the user performs the touch operation. By means of the keys in the dictionary, i.e., the display time range of the visual elements, clear indices are provided for the client, so that the client can quickly locate a time period which might contain the user’s touch time, thereby providing a guarantee for the fluency of the subsequent generation of the interactive view.

At block 308, whether the touch position corresponds to a displayed visual element is determined. It might be found after traversing the keys in the dictionary that there exist one or more displayed visual elements when the user performs the touch operation. It is also possible there are no displayed visual elements at the touch time. When there are no displayed visual elements, the traversing is ended to wait for the user’s next touch. When there are one or more displayed visual elements, all the visual elements displayed at the touch time may be traversed, and whether the touch position falls within the rectangular area of the visual element is determined one by one. In a process of determining whether the touch position corresponds to the displayed visual element, the touch position may be transformed into a coordinate system of the visual elements according to transformation information of each visual element, and then whether the touch position is within a transformed rectangular area is checked.

In some embodiments, when the touch position is within the transformed rectangular area, which proves that the touch position corresponds to the displayed visual element, block 310 is performed to generate an interactive view corresponding to the displayed visual element. The information of the interactive view corresponding to the visual element touched by the user can be acquired through the video draft received from the video engine; after acquiring the information of the interactive view, the client may determine information of the interactive view such as the style, the position and the display time range, and then generate the interactive view and render the interactive view to a position corresponding to the visual element. When the touch position is not in the transformed rectangular area, which proves that the touch position does not correspond to the displayed visual element, block 312 is executed to wait for the next touch operation.

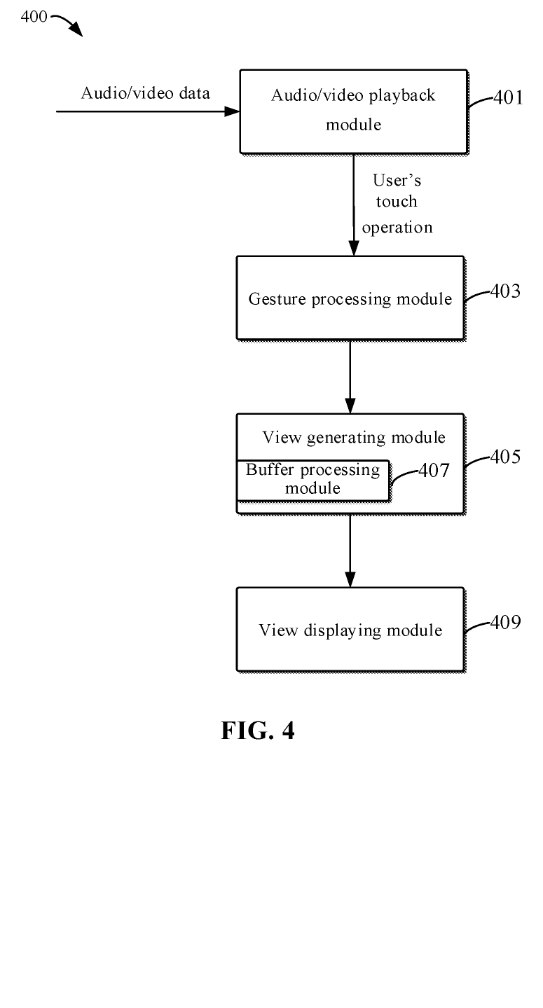

FIG. 4 illustrates a schematic diagram of an example 400 of a module that generates and displays an interactive view according to some embodiments of the present disclosure. As shown in FIG. 4, a client may be provided with an audio/video playback module 401, a gesture processing module 403, a view generation module 405, a buffer processing module 407, and a view displaying module 409. The audio/video playback module 401 is configured to receive audio/video data, and be responsible for decoding and playing the audio and video. The audio/video playback module 401 is configured to acquire information of a visual element and information of an interactive view according to the received audio/video data, and store the acquired information in a dictionary. The gesture processing module 403 is configured to monitor the user’s interactive touch operation such as a click to acquire a touch position and a touch time.

As shown in FIG. 4, the view management module 405 is configured to manage an interactive view, comprising generating, destroying and buffering the interactive view; in the process of generating the interactive view, the view management module 405 may traverse keys in the dictionary, find a display time range corresponding to the touch time, determine a visual element displayed at the touch time according to the display time range, and then may determine whether the touch position corresponds to position information of the displayed visual element; and generate an interactive view according to the acquired information of the interactive view when the touch position is within a rectangular area of the visual element. The generated interactive view may be stored in a buffer pool of the buffer processing module 407. The view displaying module 409 is configured to display the generated interactive view on the screen. If the interactive view has been previously generated, it may be reused. The view displaying module 409 may retrieve the interactive view from the buffer processing module 407 for reuse. In this manner, memory consumption and redundancy can be reduced, thereby improving system performance and efficiency and enhancing the fluency of the interaction.

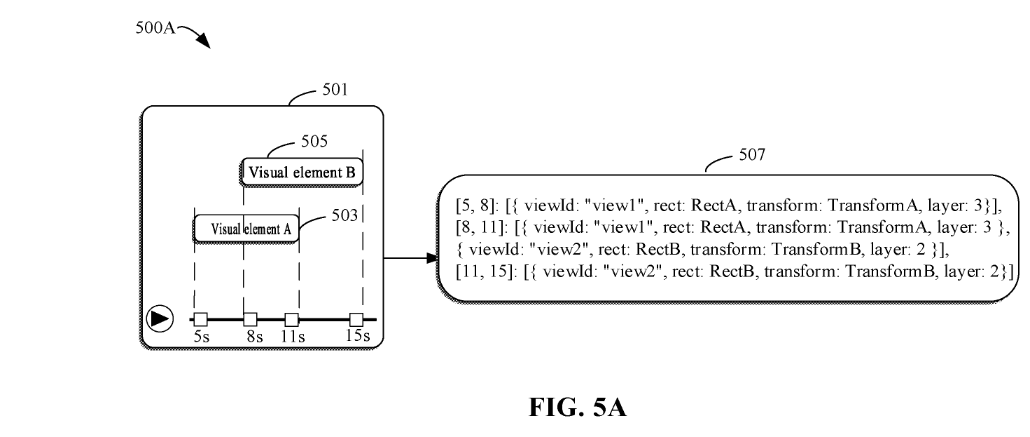

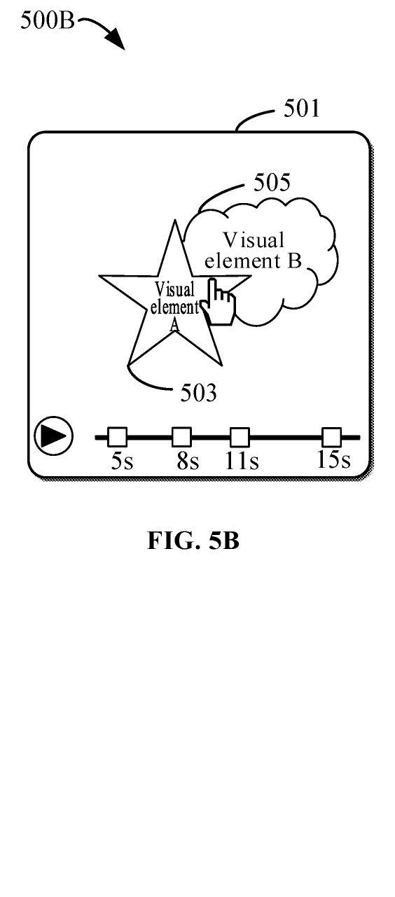

FIG. 5A illustrates a schematic diagram of an example 500A of creating a dictionary according to some embodiments of the present disclosure. In some embodiments, in one display time range, a plurality of visual elements need to be displayed. For example, as shown in FIG. 5, in video 501, the display time range of the visual element A 503 from the 5^{th} second to the 11^{th} second, and the display time range of the visual element B 503 is from the 8^{th} second to the 15^{th} second. At this time, the visual element A 503 and visual element B 503 are simultaneously displayed in the time range from the 8^{th} second to the 11^{th} second. In an embodiment of the present disclosure, for a plurality of visual elements having an intersection of display time ranges, the intersection of the display time ranges may be taken as an intersection key, and the information of the plurality of visual elements may be stored as an intersection value in the dictionary. For example, in dictionary 507, the [5, 8]-second key corresponds to the information of the visual element A 503, the [8, 11]-second key corresponds to the information of the visual element A 503 and the visual element B 503, and the [11, 15]-second key corresponds to the information of the visual element B 503. That is to say, if the display time ranges of the plurality of visual elements overlap, the information of the visual element may be collectively stored in an overlapping portion of two time periods, and stored separately in non-overlapping portions of the two time periods. In the optimized storage manner with a difference set and an intersection set, repeated storage can be avoided so that the client can more efficiently retrieve the information of the visual element upon processing the user’s touch operation.

FIG. 5B illustrates a schematic diagram of an example 500B of generating an interactive view based on hierarchy information according to some embodiments of the present disclosure. In some embodiments, for a plurality of visual elements with an intersection of display time ranges, display areas thereof might also overlap. When the user’s touch position falls within position areas of the plurality of visual elements simultaneously, the visual elements to be preferentially responded to may be determined according to the hierarchy information of each visual element. For example, on the display page of the video 501, a hierarchy of the visual element A 503 is higher than that of the visual element B 501; when the user’s touch position falls within both the position area of the visual element A 503 and the position area of the visual element B 501, an interactive view corresponding to the visual element A 503 should be generated. In this way, it is possible to process the user’s input more intelligently and flexibly, and improve the accuracy of the response of the system and the usability of the user interface, especially in a complex user interface environment.

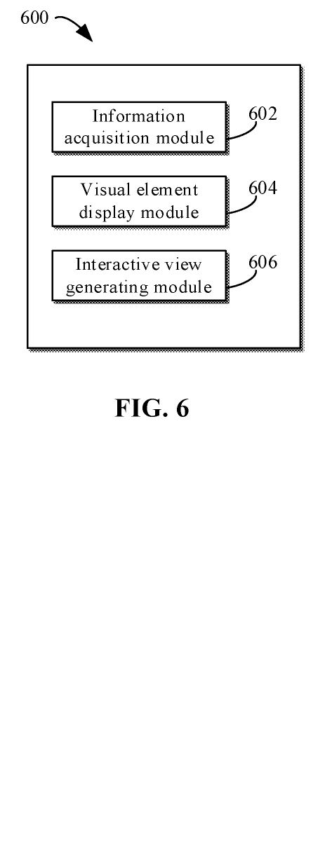

FIG. 6 illustrates a block diagram of an apparatus 600 for generating an interactive view according to some embodiments of the present disclosure. As shown in FIG. 6, the apparatus 600 comprises an information acquisition module 602 configured to acquire information of visual elements in an audio or video. The apparatus 600 comprises a visual element display module 604 configured to display the visual element during playback of the audio or video based on information of the visual element. In addition, the apparatus 600 further comprises an interactive view generation module 606 configured to generate an interactive view corresponding to the visual element in response to a user’s touch operation on the displayed visual element.

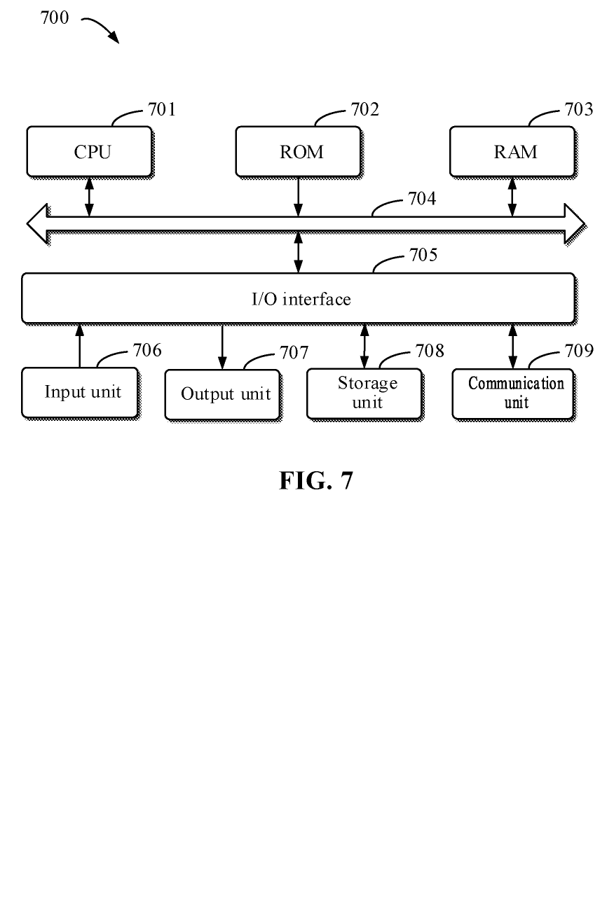

FIG. 7 illustrates a block diagram of a device 700 capable of implementing embodiments of the present disclosure. As shown in FIG. 7, the device 700 comprises a central processing unit (CPU) and/or graphics processing unit (GPU) 701 which may perform various suitable acts and processes in accordance with computer program instructions stored in a Read Only Memory (ROM) 702 or computer program instructions loaded from a storage unit 708 into a Random Access Memory (RAM) 703. In the RAM 703, various programs and data needed by the operation of the device 700 are also stored. The CPU/GPU 701, the ROM 702, and the RAM 703 are connected to one another via a bus 704. An input/output (I/O) interface 705 is also coupled to the bus 704. Although not shown in FIG. 7, the device 700 may further comprise a coprocessor.

Multiple components in the device 700 may be connected to the I/O interface 705: an input unit 706 including, for example, a keyboard, a mouse, etc.; an output unit 707 including various displays, speakers etc.; a storage unit 708 such as a magnetic disk, a CD etc.; and a communication unit 709 such as a network card, a modem, a wireless communication transceiver, etc. The communication unit 709 allows the device 700 to exchange information/data with other devices over a computer network, such as the Internet, and/or various telecommunication networks.

The methods or processes described above may be performed by CPU/GPU 701. For example, in some embodiments, the methods may be implemented as a computer software program tangibly embodied on a machine-readable medium, such as the storage unit 708. In some embodiments, part or all of the computer program may be loaded and/or installed on the device 700 via the ROM 702 and/or the communication unit 709. When the computer program is loaded into the RAM 703 and executed by the CPU/GPU 701, one or more steps or actions in the methods or processes described above may be performed.

In some embodiments, the methods and processes described above may be implemented as a computer program product. The computer program product may include a computer-readable storage medium having computer-readable program instructions embodied thereon for performing the aspects of the present disclosure.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium comprises the following: a portable computer diskette, a hard disk, a Random Access Memory (RAM), a Read-Only Memory (ROM), an Erasable Programmable Read-Only Memory (EPROM or Flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

The computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language and conventional procedural programming languages. The computer readable program instructions may execute entirely on the user’s computer, partly on the user’s computer, as a stand-alone software package, partly on the user’s computer and partly on a remote computer or entirely on the remote computer or server. In the scenario involving the remote computer, the remote computer may be connected to the user’s computer through any type of network, including a Local Area Network (LAN) or a Wide Area Network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to perform aspects of the present disclosure.

These computer readable program instructions may be provided to a processing unit of a general-purpose computer, a special-purpose computer, or other programmable data processing apparatus to produce a machine, such that the instructions, when executed via the processing unit of the computer or other programmable data processing apparatus, create means for implementing the functions/acts specified in one or more blocks in the flowcharts and/or block diagrams. These computer readable program instructions may also be stored in a computer readable storage medium and cause a computer, a programmable data processing apparatus, and/or other devices to function in a specific manner, such that the computer readable storage medium having instructions stored therein comprises an article of manufacture including instructions which implement aspects of the functions/acts specified in one or more blocks in the flowcharts and/or block diagrams.

The computer readable program instructions may also be loaded onto a computer, other programmable data processing apparatus, or other devices to cause a series of operational steps to be performed on the computer, other programmable apparatus or other device to produce a computer-implemented process, such that the instructions executed on the computer, other programmable apparatus, or other devices implement the functions/acts specified in one or more blocks in the flowcharts and/or block diagrams.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, may be implemented by special-purpose hardware-based systems that perform the specified functions or acts, or implemented by combinations of special-purpose hardware and computer instructions.

The above depictions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Some example implementations of the present disclosure are listed below.

Example 1. A method for generating an interactive view, comprising:

acquiring information of a visual element in an audio or video; displaying the visual element during playback of the audio or video based on the information of the visual element; and generating an interactive view corresponding to the visual element in response to a user’s touch operation on the displayed visual element.

Example 2. The method according to Example 1, wherein the acquiring information of a visual element in an audio or video comprises:

acquiring a display time range, position information, transformation information and/or hierarchy information of the visual element; and in a chronological order of the display time range, taking the display time range of the visual element as a key, and storing the position information, the transformation information and/or the hierarchy information in a dictionary as values.

Example 3. The method according to any of Examples 1-2, wherein the visual element comprises a first visual element and a second visual element, the display time range of the first visual element and the display time range of the second visual element have an intersection, and wherein the taking the display time range of the visual element as a key, and storing the position information, the transformation information and/or the hierarchy information in a dictionary as values comprises:

taking the display time range within the intersection as an intersection key, and storing the position information, the transformation information and/or the hierarchy information of the first visual element and the position information, the transformation information and/or the hierarchy information of the second visual element in the dictionary as intersection values corresponding to the intersection key.

Example 4. The method according to any of Examples 1-3, wherein generating an interactive view corresponding to the visual element comprises:

determining the user’s touch time and touch position in response to the user’s touch operation on the audio or video; determining a displayed visual element in response to the user performing the touch operation, based on the touch time and the dictionary; determining whether the touch position corresponds to the displayed visual element; and in response to the touch position corresponding to the displayed visual element, generating an interactive view corresponding to the displayed visual element.

Example 5. The method according to any of Examples 1-4, wherein determining a displayed visual element in response to the user performing the touch operation comprises:

determining the display time range corresponding to the touch time by traversing the keys in the dictionary; and determining the displayed visual element in response to the user performing the touch operation, based on the display time range corresponding to the touch time.

Example 6. The method according to any of Examples 1-5, wherein determining whether the touch position corresponds to the displayed visual element comprises:

determining a display area of the displayed visual element based on the position information and the transformation information of the displayed visual element; and determining, based on the display area and the touch position, whether the touch position corresponds to the displayed visual element through a collision detection.

Example 7. The method according to any of Examples 1-6, wherein the touch position simultaneously corresponds to the first visual element and second visual element, and the generating an interactive view corresponding to the displayed visual element further comprises:

determining whether a hierarchy of the first visual element is greater than hierarchy of the second visual element based on hierarchy information of the first visual element and hierarchy information of the second visual element; in response to the hierarchy of the first visual element being greater than the hierarchy of the second visual element, generating an interactive view corresponding to the first visual element; and in response to the hierarchy of the first visual element being less than the hierarchy of the second visual element, generating an interactive view corresponding to the second visual element.

Example 8. The method according to any of Examples 1-7, further comprising:

displaying, in the audio or video, the interactive view corresponding to the visual element, wherein the interactive view causes the user to implement interaction with an audio or video engine.

Example 9. The method according to any of Examples 1-8, further comprising:

storing the interactive view in a buffer pool; and in response to the user’s touch operation on the displayed visual element, invoking the generated interactive view corresponding to the visual element from the buffer pool.

Example 10. An apparatus for generating an interactive view, comprising:

an information acquisition module configured to acquire information of a visual element in an audio or video; a visual element display module configured to display the visual element during playback of the audio or video based on the information of the visual element; and an interactive view generation module configured to generate an interactive view corresponding to the visual element in response to a user’s touch operation on the displayed visual element.

Example 11. The apparatus according to Example 10, wherein the information acquisition module comprises:

a first acquisition module configured to acquire a display time range, position information, transformation information and/or hierarchy information of the visual element; and a dictionary creation module configured to, in a chronological order of the display time range, take the display time range of the visual element as a key, and storing the position information, the transformation information and/or the hierarchy information in a dictionary as values.

Example 12. The apparatus according to any of Examples 10-11, wherein the visual element comprises a first visual element and a second visual element, the display time range of the first visual element and the display time range of the second visual element have an intersection, and wherein the dictionary creation module comprises:

a first creation module configured to take the display time range within the intersection as an intersection key, and store the position information, the transformation information and/or the hierarchy information of the first visual element and the position information, the transformation information and/or the hierarchy information of the second visual element in the dictionary as intersection values corresponding to the intersection key.

Example 13. The apparatus according to any of Examples 10-12, wherein interactive view generation module comprises:

a touch determination module configured to determine the user’s touch time and touch position in response to the user’s touch operation on the audio or video; a visual element determination module configured to determine a displayed visual element in response to the user performing the touch operation, based on the touch time and the dictionary; a first correspondence determination module configured to determine whether the touch position corresponds to the displayed visual element; and

a first view generation module configured to, in response to the touch position corresponding to the displayed visual element, generate an interactive view corresponding to the displayed visual element.

Example 14. The apparatus according to any of Examples 10-13, wherein the visual element determination module comprises:

a dictionary traversing module configured to determine the display time range corresponding to the touch time by traversing the keys in the dictionary; and a first element determination module configured to determine the displayed visual element in response to the user performing the touch operation, based on the display time range corresponding to the touch time.

Example 15. The apparatus according to any of Examples 10-14, wherein first correspondence determination module comprises:

a display area determination module configured to determine a display area of the displayed visual element based on the position information and the transformation information of the displayed visual element; and a second correspondence determination module configured to determine, based on the display area and the touch position, whether the touch position corresponds to the displayed visual element through a collision detection.

Example 16. The apparatus according to any of Examples 10-15, wherein the touch position simultaneously corresponds to the first visual element and the second visual element, and interactive view generation module further comprises:

a hierarchy determination module configured to determine whether a hierarchy of the first visual element is greater than hierarchy of the second visual element based on hierarchy information of the first visual element and hierarchy information of the second visual element; a second view generation module configured to, in response to the hierarchy of the first visual element being greater than the hierarchy of the second visual element, generate an interactive view corresponding to the first visual element; and a third view generation module configured to, in response to the hierarchy of the first visual element being less than the hierarchy of the second visual element, generate an interactive view corresponding to the second visual element.

Example 17. The apparatus according to any of Examples 10-16, further comprising:

an interactive view display module configured to display, in the audio or video, the interactive view corresponding to the visual element, wherein the interactive view causes the user to implement interaction with an audio or video engine.

Example 18. The apparatus according to any of Examples 10-17, further comprising:

a storage module configured to store the interactive view in a buffer pool; and a view reuse module configured to, in response to the user’s touch operation on the displayed visual element, invoke the generated interactive view corresponding to the visual element from the buffer pool.

Example 19. An electronic device, comprising:

a processor; and a memory coupled to the processor, the memory having instructions stored therein that, when executed by the processor, cause the electronic device to perform actions, the actions comprising: acquiring information of a visual element in an audio or video; displaying the visual element during playback of the audio or video based on the information of the visual element; and generating an interactive view corresponding to the visual element in response to a user’s touch operation on the displayed visual element.

Example 20. The electronic device according to Example 19, wherein the acquiring information of a visual element in an audio or video comprises:

acquiring a display time range, position information, transformation information and/or hierarchy information of the visual element; and in a chronological order of the display time range, taking the display time range of the visual element as a key, and storing the position information, the transformation information and/or the hierarchy information in a dictionary as values.

Example 21. The electronic device according to any of Examples 19-20, wherein the visual element comprises a first visual element and a second visual element, the display time range of the first visual element and the display time range of the second visual element have an intersection, and wherein the taking the display time range of the visual element as a key, and storing the position information, the transformation information and/or the hierarchy information in a dictionary as values comprises:

taking the display time range within the intersection as an intersection key, and storing the position information, the transformation information and/or the hierarchy information of the first visual element and the position information, the transformation information and/or the hierarchy information of the second visual element in the dictionary as intersection values corresponding to the intersection key.

Example 22. The electronic device according to any of Examples 19-21, wherein generating an interactive view corresponding to the visual element comprises:

determining the user’s touch time and touch position in response to the user’s touch operation on the audio or video; determining a displayed visual element in response to the user performing the touch operation, based on the touch time and the dictionary; determining whether the touch position corresponds to the displayed visual element; and in response to the touch position corresponding to the displayed visual element, generating an interactive view corresponding to the displayed visual element.

Example 23. The electronic device according to any of Examples 19-22, wherein determining a displayed visual element displayed when the user performing the touch operation comprises:

determining the display time range corresponding to the touch time by traversing the keys in the dictionary; and determining the displayed visual element in response to the user performing the touch operation, based on the display time range corresponding to the touch time.

Example 24. The electronic device according to any of Examples 19-23, wherein determining whether the touch position corresponds to the displayed visual element comprises:

determining a display area of the displayed visual element based on the position information and the transformation information of the displayed visual element; and determining, based on the display area and the touch position, whether the touch position corresponds to the displayed visual element through a collision detection.

Example 25. The electronic device according to any of Examples 19-24, wherein the touch position simultaneously corresponds to the first visual element and the second visual element, and generating an interactive view corresponding to the displayed visual element further comprises:

determining whether a hierarchy of the first visual element is greater than hierarchy of the second visual element based on hierarchy information of the first visual element and hierarchy information of the second visual element; in response to the hierarchy of the first visual element being greater than the hierarchy of the second visual element, generating an interactive view corresponding to the first visual element; and in response to the hierarchy of the first visual element being less than the hierarchy of the second visual element, generating an interactive view corresponding to the second visual element.

Example 26. The electronic device according to any of Examples 19-25, further comprising:

displaying, in the audio or video, the interactive view corresponding to the visual element, wherein the interactive view causes the user to implement interaction with an audio or video engine.

Example 27. The electronic device according to any of Examples 19-26, further comprising:

storing the interactive view in a buffer pool; and in response to the user’s touch operation on the displayed visual element, invoking the generated interactive view corresponding to the visual element from the buffer pool.

Example 28. A computer-readable storage medium having stored thereon computer-executable instructions, wherein the computer-executable instructions are executed by a processor to perform the method according to any of Examples 1 to 9.

Example 29. A computer program product tangibly stored on a computer-readable medium and comprising computer-executable instructions, the computer-executable instructions, when executed by an apparatus, cause the apparatus to perform the method according to any of Examples 1 to 9.

Although the subject matter has been described in language specific to structural features and/or methodological actions, it should be understood that the subject matters specified in the appended claims are not limited to the specific features or actions described above. Rather, the specific features and actions described above are disclosed as example forms of implementing the claims.

We claim:

1. A method for generating an interactive view, comprising:
acquiring information of a visual element in an audio or video;
displaying the visual element during playback of the audio or video based on the information of the visual element; and
generating an interactive view corresponding to the visual element in response to a user’s touch operation on the displayed visual element.

2. The method according to claim 1, wherein the acquiring information of a visual element in an audio or video comprises:
acquiring a display time range, position information, transformation information and/or hierarchy information of the visual element; and
in a chronological order of the display time range, taking the display time range of the visual element as a key, and storing the position information, the transformation information and/or the hierarchy information in a dictionary as values.

3. The method according to claim 2, wherein the visual element comprises a first visual element and a second visual element, the display time range of the first visual element and the display time range of the second visual element have an intersection, and wherein the taking the display time range of the visual element as a key, and storing the position information, the transformation information and/or the hierarchy information in a dictionary as values comprises:
taking the display time range within the intersection as an intersection key, and storing the position information, the transformation information and/or the hierarchy information of the first visual element and the position information, the transformation information and/or the hierarchy information of the second visual element in the dictionary as intersection values corresponding to the intersection key.

4. The method according to claim 3, wherein generating an interactive view corresponding to the visual element comprises:
determining the user’s touch time and touch position in response to the user’s touch operation on the audio or video;
determining a displayed visual element in response to the user performing the touch operation, based on the touch time and the dictionary;
determining whether the touch position corresponds to the displayed visual element; and
in response to the touch position corresponding to the displayed visual element, generating an interactive view corresponding to the displayed visual element.

5. The method according to claim 4, wherein determining a displayed visual element in response to the user performing the touch operation comprises:
determining the display time range corresponding to the touch time by traversing the keys in the dictionary; and
determining the displayed visual element in response to the user performing the touch operation, based on the display time range corresponding to the touch time.

6. The method according to claim 4, wherein determining whether the touch position corresponds to the displayed visual element comprises:
determining a display area of the displayed visual element based on the position information and the transformation information of the displayed visual element; and
determining, based on the display area and the touch position, whether the touch position corresponds to the displayed visual element through a collision detection.

7. The method according to claim 4, wherein the touch position simultaneously corresponds to the first visual element and the second visual element, and generating an interactive view corresponding to the displayed visual element further comprises:
determining whether a hierarchy of the first visual element is greater than a hierarchy of the second visual element based on hierarchy information of the first visual element and hierarchy information of the second visual element;
in response to the hierarchy of the first visual element being greater than the hierarchy of the second visual element, generating an interactive view corresponding to the first visual element; and
in response to the hierarchy of the first visual element being less than the hierarchy of the second visual element, generating an interactive view corresponding to the second visual element.

8. The method according to claim 1, further comprising:
displaying, in the audio or video, the interactive view corresponding to the visual element, wherein the interactive view causes the user to implement interaction with an audio or video engine.

9. The method according to claim 1, further comprising:
storing the interactive view in a buffer pool; and
in response to the user’s touch operation on the displayed visual element, invoking the generated interactive view corresponding to the visual element from the buffer pool.

10. An electronic device, comprising:
a memory and a processor;
wherein the memory is configured to store one or more computer instructions which, when executed by the processor, cause the processor to:
acquire information of a visual element in an audio or video;
display the visual element during playback of the audio or video based on the information of the visual element; and
generate an interactive view corresponding to the visual element in response to a user’s touch operation on the displayed visual element.

11. The device according to claim 10, wherein the instructions causing the processor to acquire information of a visual element in an audio or video comprise instructions causing the processor to:
acquire a display time range, position information, transformation information and/or hierarchy information of the visual element; and
in a chronological order of the display time range, take the display time range of the visual element as a key, and store the position information, the transformation information and/or the hierarchy information in a dictionary as values.

12. The device according to claim 11, wherein the visual element comprises a first visual element and a second visual element, the display time range of the first visual element and the display time range of the second visual element have an intersection, and wherein the instructions causing the processor to take the display time range of the visual element as a key, and store the position information, the transformation information and/or the hierarchy information in a dictionary as values comprise instructions causing the processor to:
take the display time range within the intersection as an intersection key, and store the position information, the transformation information and/or the hierarchy information of the first visual element and the position information, the transformation information and/or the hierarchy information of the second visual element in the dictionary as intersection values corresponding to the intersection key.

13. The device according to claim 12, wherein the instructions causing the processor to generate an interactive view corresponding to the visual element comprise instructions causing the processor to:
determine the user’s touch time and touch position in response to the user’s touch operation on the audio or video;
determine a displayed visual element in response to the user performing the touch operation, based on the touch time and the dictionary;
determine whether the touch position corresponds to the displayed visual element; and
in response to the touch position corresponding to the displayed visual element, generate an interactive view corresponding to the displayed visual element.

14. The device according to claim 13, wherein the instructions causing the processor to determine a displayed visual element in response to the user performing the touch operation comprise instructions causing the processor to:
determine the display time range corresponding to the touch time by traversing the keys in the dictionary; and
determine the displayed visual element in response to the user performing the touch operation, based on the display time range corresponding to the touch time.

15. The device according to claim 13, wherein the instructions causing the processor to determine whether the touch position corresponds to the displayed visual element comprise instructions causing the processor to:
determine a display area of the displayed visual element based on the position information and the transformation information of the displayed visual element; and
determine, based on the display area and the touch position, whether the touch position corresponds to the displayed visual element through a collision detection.

16. The device according to claim 13, wherein the touch position simultaneously corresponds to the first visual element and the second visual element, and wherein the instructions causing the processor to generate an interactive view corresponding to the displayed visual element further comprise instructions causing the processor to:
determine whether a hierarchy of the first visual element is greater than hierarchy of the second visual element based on hierarchy information of the first visual element and hierarchy information of the second visual element;
in response to the hierarchy of the first visual element being greater than the hierarchy of the second visual element, generate an interactive view corresponding to the first visual element; and
in response to the hierarchy of the first visual element being less than the hierarchy of the second visual element, generate an interactive view corresponding to the second visual element.

17. The device according to claim 10, further comprising instructions causing the processor to:
display, in the audio or video, the interactive view corresponding to the visual element, wherein the interactive view causes the user to implement interaction with an audio or video engine.

18. The device according to claim 10, further comprising instructions causing the processor to:
store the interactive view in a buffer pool; and
in response to the user’s touch operation on the displayed visual element, invoke the generated interactive view corresponding to the visual element from the buffer pool.

19. A non-transitory computer-readable medium comprising instructions stored thereon which, when executed by a processor, cause the processor to:
acquire information of a visual element in an audio or video;
display the visual element during playback of the audio or video based on the information of the visual element; and
generate an interactive view corresponding to the visual element in response to a user’s touch operation on the displayed visual element.

20. The medium according to claim 19, wherein the instructions causing the processor to acquire information of a visual element in an audio or video comprise instructions causing the processor to:
acquire a display time range, position information, transformation information and/or hierarchy information of the visual element; and
in a chronological order of the display time range, take the display time range of the visual element as a key, and store the position information, the transformation information and/or the hierarchy information in a dictionary as values.
